(19) United States
(12) Patent Application Publication
(10) Pub. No.: US 2008/0271402 A1
(43) Pub. Date: Nov. 6, 2008

(54) CUSTOMIZED MODULAR PANEL

(76) Inventor: Jean-Pierre GINGRAS, Longueuil (CA)

Correspondence Address: BENOIT & CO., 2025 Limoges Street, LONGUEUIL - QUEBEC, J4G 1C4, CA

(21) Appl. No.: 11/743,861

(22) Filed: May 3, 2007

(51) Int. Cl. E04B 5/00; B23P 17/00

(52) U.S. Cl. 52/506.02; 29/897.32

(57) ABSTRACT

There is described a method for fabricating a modular panel, the method comprising a continuous production cycle comprising: providing a space between two parallel exterior faces continuously supplied, the space also enclosed between two opposite outer edges; positioning a fastener within the space, along at least one of the two opposite outer edges, the positioning performed at a given rate to form a customized and predetermined pattern, and while the space is being provided; at least partially filling the space with an insulation layer, the insulation layer being also used for holding said fastener in place; and cutting at least the insulation layer to form the modular panel, the cutting according to the customized and predetermined pattern. There is also provided a modular panel having two parallel exterior faces for enclosing a space and a fastener, said fastener being positioned within said space during the above-mentioned continuous production cycle.

### BACKGROUND

1) Field

The invention relates to the construction of insulated rooms and to prefabricated panels for the construction of insulated rooms or walk-in refrigeration units.

2) Description of the Prior Art

Insulated rooms and refrigeration units are generally constructed using prefabricated insulated modular panels made of an insulating core enclosed within galvanized steel outer surfaces.

Various modular panel fabrication techniques are found in the prior art. In one example, each panel is fabricated manually according to desired panel shapes and attributes. The panels are thus produced to be able to build a customized insulated room. This technique is quite time consuming and expensive however, as it requires much labour. The locking devices, or fasteners, as well as other joint features necessary for assembling the panels together, are inserted during the manual fabrication process.

Another known fabrication technique seen in the prior art employs an automated continuous manufacturing line to produce panels having substantially fixed attributes. While this approach reduces fabrication costs compared to the manual process, the resulting panels have standard shapes and features, without any built-in locking devices and custom junctions. Some panels are then cut at the construction site in order to build a customized insulated room. The assembly and the intersections are crafted after pre-fabrication in order to assemble the panels together to form panel junctions, intersectional walls, roof, floor and other features of the room.

### SUMMARY

There is therefore a need overcome the shortcomings of the prior art as detailed herein above and to provide a continuous fabrication process for creating modular panels capable of being assembled together to create a customized insulated room.

According to one aspect, there is provided a modular panel comprising: two opposite outer edges; a fastener positioned within the space, along at least one of the two opposite outer edges; two parallel exterior faces having a space therebetween, the space also enclosed within the two opposite outer edges; an insulation layer at least partially filling the space during a continuous fabrication process, and for holding the fastener in place; and a positioning device for positioning the fastener, the positioning device being in contact with the fastener and with at least one of the two parallel exterior faces.

According to another aspect, there is provided a method for fabricating a modular panel, the method comprising a continuous production cycle comprising: providing a space between two parallel exterior faces continuously supplied, the space also enclosed between two opposite outer edges; positioning a fastener within the space, along at least one of the two opposite outer edges, the positioning performed at a given rate to form a customized and predetermined pattern, and while the space is being provided; at least partially filling the space with an insulation layer, the insulation layer being also used for holding said fastener in place; and cutting at least the insulation layer to form the modular panel, the cutting according to the customized and predetermined pattern.

According to another aspect, there is provided a modular panel having two parallel exterior faces for enclosing a space and a fastener, said fastener being positioned within said space during the above-mentioned continuous production cycle.

### BRIEF DESCRIPTION OF THE DRAWINGS

Further features will become apparent from the following detailed description, taken in combination with the appended drawings, in which:

FIG. 1 is a perspective view of a modular panel according to an embodiment;

FIG. 2 is a cross section view taken along cross-section lines 2-2 of FIG. 1;

FIG. 3a is a side view of a fabrication line according to another embodiment;

FIG. 3b is a top view of the modular panel fabrication line of FIG. 3a;

FIG. 4a is a perspective view of the modular panel of FIG. 1, with a fold line and a longitudinal V-shaped portion removed to form an angled panel;

FIG. 4b is a perspective view of the panel of FIG. 4a once folded along the fold line, glued and secured with a corner molding;

FIG. 5a is a perspective view of the modular panel of FIG. 1 with a longitudinal sectional portion removed to reduce the dimensions of the modular panel of FIG. 1;

FIG. 5b is a cross-section view of the modular panel of FIG. 5a, once the panel is fused back together to from a modular panel of a reduced size;

FIG. 6 is a cross-section view of a pair of modular panels assembled together to form an intersection;

FIG. 7a is a cross-section view of a pair of modular panels assembled together to form a roof-to-wall junction secured with a fastener;

FIG. 7b is a cross-section view of a pair of modular panels assembled together to form another roof-to-wall junction secured with a screw;

FIG. 7c is a cross-section view of the wall panel of FIG. 7b, having an embedded screwing lath;

FIG. 8a is a cross-section view of the modular panel of FIG. 1 with a floor cover to form a floor panel;

FIG. 8b is a cross-section view of a pair of modular panels assembled together to form a floor-to-wall junction;

FIG. 8c is a cross-section view of the assembled pair of modular panels of FIG. 8b, with a floor spacer;

FIG. 8d is a cross-section view of the assembled pair of modular panels of FIG. 8c, with spacers to provide a curved interior floor-to-wall junction;

FIG. 9a is a perspective view of an insulated room constructed using a plurality of modular panels as shown in FIGS. 1 through 8d, and assembled according to a customized configuration;

FIG. 9b is a top cross-section view of an assembly of modular panels forming outside walls or the perimeter of an isolated room;

FIG. 10a is a block diagram illustrating the steps involved in the method for fabricating the modular panel of FIG. 1 in accordance with another embodiment, along with subsequent steps for modifying and assembling the modular panels together to build an isolated room; and

FIG. 10b is a block diagram illustrating other steps for assembling the modular panels together, continued from FIG. 10a.

It will be noted that throughout the appended drawings, like features are identified by like reference numerals.

### DETAILED DESCRIPTION OF THE INVENTION

The fabrication process of a customized modular panel as described herein is automated such that the overall fabrication cost, fabrication time, on-site complexity of assembly and amount of waste material may be reduced. In effect, the proposed modular panel fabrication and assembly aims at improving the limitations found in the prior art.

An embodiment of a modular panel is initially described, followed by a the explanation of an automated fabrication process used to fabricate the modular panel. Further modifications of the resulting pre-fabricated, customized modular panels are then described, along with their assembly for the construction of a structure herein described as an insulated room. It is understood that the described customized modular panels can be used to assemble other similar structures

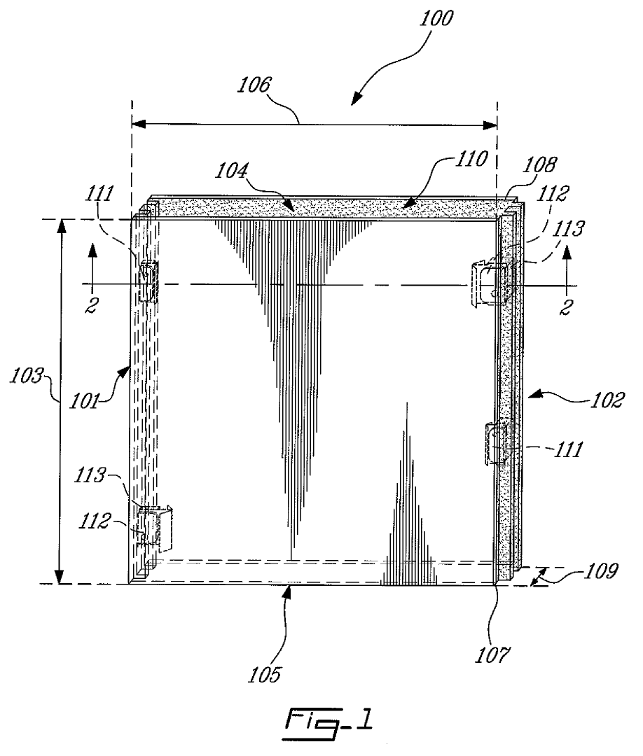

Referring to FIG. 1, a modular panel 100 for making an isolated room 900 or a refrigeration unit (see FIG. 9a) is shown. The modular panel 100 has two opposite outer edges, 101 and 102, distanced by a width 106. The modular panel 100 also has a height 103 defined by the distance between the two opposite cut ends, 104 and 105, of the modular panel 100. The two opposite cut ends 104 and 105 are substantially perpendicular to the two opposite outer edges 101 and 102. The modular panel 100 also has two parallel exterior faces, 107 and 108, defining a space 109 therebetween also referred to as a panel thickness. The space 109 between the to parallel exterior faces, 107 and 108, is at least partially filled with an insulation layer 110.

The two parallel exterior faces, 107 and 108 are not necessary, although they are usually composed of a sheet of material made of a plastic substance for example, or a metal such as aluminum and galvanized steel.

The modular panel 100 has fasteners 111 and 112, which are placed between the two parallel exterior faces, 107 and 108, substantially near at least one of the two opposite outer edges, 101 and 102. The fasteners 111 and 112 are positioned by a positioning device 113 during an automated continuous fabrication process. For example, the fasteners can be positioned while or before the insulation layer 110 is being inserted, in a way that they remain in place while the panel is filled with the insulation layer 110.

Still referring to FIG. 1, the fasteners 111 and 112 are placed along at least one of the two opposite outer edges 101 and 102. A number of female fasteners 111 are placed along one of the two opposite outer edges 101, and a number of male fasteners 112 are positioned along the second opposite outer edge 102. Another possibility, as shown, is to alternate female fasteners 111 and male fasteners 112 along the same outer edge (101 or 102). The number of fasteners 111 and 112, as well as their type and position along either one of the two opposite outer edges 101 and 102, is pre-determined according to a given pattern based on the customer's desires, for example.

Alternatively, a given modular panel height 103 (the distance between the two opposite cut ends 104 and 105) can also be used to determine the exact positions of the fasteners once the number of fasteners to be placed along one outer edge (102 or 103) is set. Other schemes may also be used to determine how the fasteners are placed within the modular panel 100. For example, a customized or predetermined pattern setting the number of male and female fasteners, and a series of given fastener positions, can be pre-established using a customizing software run on a computer connected to an automated continuous fabrication line. The software determines where the fasteners 111 and 112 should be placed in the modular panel and when they should be positioned during the fabrication process, such that the panels can later be assembled together to form the desired insulated room. The given pattern is then used by the computer and an encoder during the fabrication process. The encoder sends signals to the appropriate fabricating devices of the automated continuous fabrication line, in accordance with the given pattern

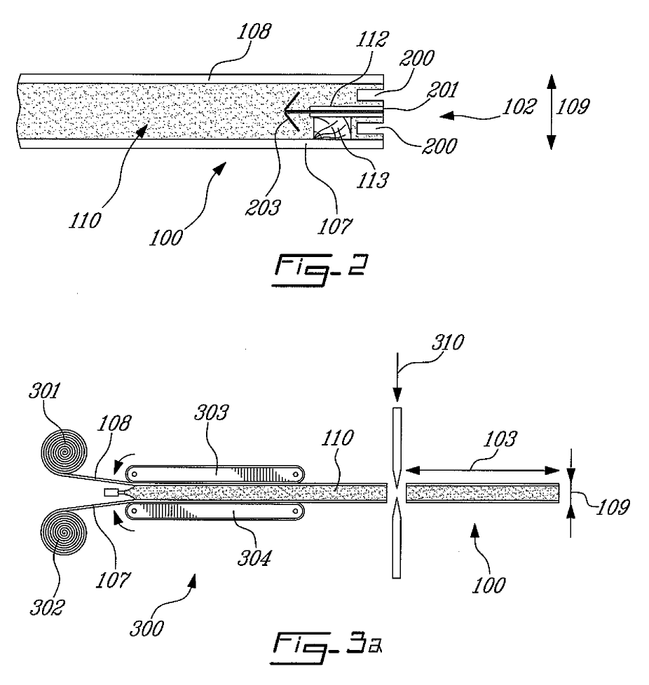

Now referring to FIG. 2, which shows a cross-section view of the modular panel 100 of FIG. 1 along the lines 2-2, either one of the two opposite cut ends (not shown) or either one of the two opposite outer edges, here 102, can have grooves 200 for assembling with a second modular panel (not shown) having correspondingly fitting grooves such that both modular panels can be assembled together.

FIG. 2 also illustrates the two parallel exterior faces 107 and 108, the insulating layer 110, and the fastener (111 or 112; here 112) placed along an outer edge (101 or 102; here 102). The key 201 of the fastener 112 is near the outer edge 102, and the two wings 203 of the fastener 112 are inserted further inside the insulation layer 110 of the modular panel 100. The key 201 of a male fastener is a hook-like device, whereas the key of a female fastener (not shown) is a device having an element for attaching to the key 201 of a male fastener, such as a latch pin.

Still referring to FIG. 2, a positioning device 113 is used during the fabrication process to at least partially hold the fastener 112 in place within the space 109 or between the two parallel exterior faces 107 and 108. The positioning device 113 can be a simple supporting block of material, as illustrated. Alternatively, a portion of the fastener (111 or 112), can be made to extend from the fastener or one of its two wings 203, for example. Such an extension or block of material supports the fastener within the space 109 or on one of the two exterior faces 107 and 108. The positioning device can be secured to the fastener (111 and 112) or to one of the two exterior faces 107 and 108 using adhesives (not shown). Yet another alternative is to simply secure the fastener in place using adhesives.

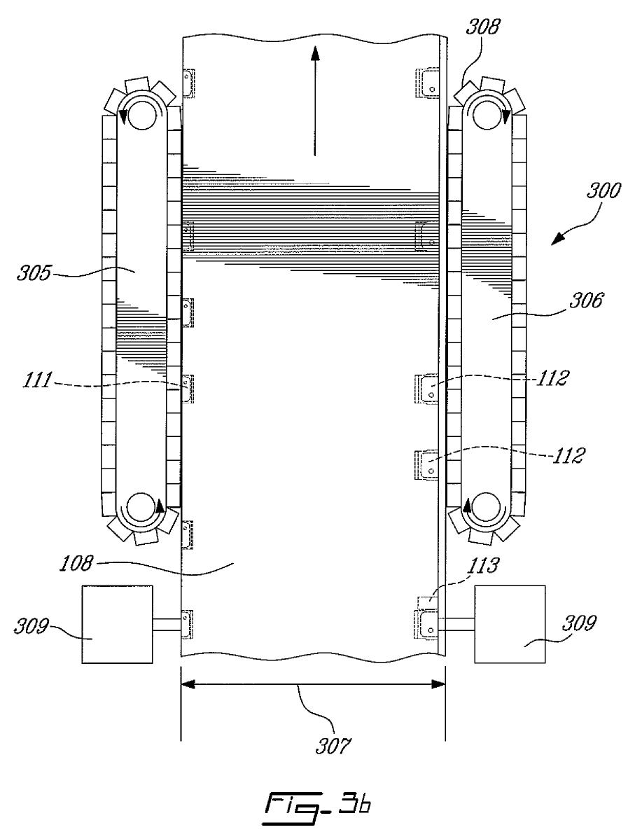

Now referring to FIG. 3a, there is illustrated an automated continuous fabrication line 300 used for fabricating the modular panel 100 according to one embodiment. The side view of the fabrication line shows the two parallel exterior faces 107 and 108 being continuously provided by unrolling two wheels of sheet material 301 and 302. The exterior faces 107 and 108 may form part of the modular panel 100 or only be used during the fabrication to enclose the space 109 such that it is filled by an insulating material.

The two wheels of sheet material 301 and 302 provide for the two parallel exterior faces 107 and 108 of the panel 100. The double conveyor belts 303 and 304 continuously unroll the wheels 301 and 302 to provide the enclosed space 109 which is also continuously being filled with the insulating material.

Referring to FIG. 3b, which is a top view of the continuous fabrication line 300 of FIG. 3a, two side conveyor belts 305 and 306 are placed along each of the two opposite outer edges 101 and 102 of the modular panel 100 being fabricated. The two side conveyor belts 305 and 306 are therefore separated by the width 307.

The side conveyor belt 305 and 306 can have continuous and flexible side molding device (not shown) to create the grooves 200 of the modular panel 100 (refer to FIG. 2). Alternatively, and as illustrated, the side conveyor belt 305 and 306 can have small blocks of material 308 each having molding grooves to form corresponding grooves 200 within the outer edges (101 and 102) of the panel 100 (refer to FIGS. 1 and 2).

The fabrication line 300 also has two manipulating arms 309 for inserting at least the fasteners in place along the two opposite outer edges 101 and 102 and within the space 109 of the modular panel 100 (refer to FIG. 3a). Positioning devices 113 can be used to hold the fasteners in place at least while the space 109 is being filled with the insulation layer 110. The insulation layer 110, once inserted, will secure the fasteners 111 and 112 in place.

Still referring to the fabrication line 300 of FIGS. 3a and 3b, a computer (not shown) controls the fabrication line 300 by executing a customizable fabrication software (not shown). The computer controls several industrial programmable logic controllers (not shown), and at least one encoder (not shown) for measuring a length of material passing through the fabrication line 300. The length is measured and encoded by the encoder, and sent to the central computer. The central computer uses the encoder's information to direct the manipulating arms 309 such that they place the fasteners 111 and 112 at the appropriate positions. These steps are all performed while the panel passes through the fabrication line 300. The length measured by the encoder is thus the length of the panel being fabricated. This fabrication technique can be customized and the panel can be fabricated according to a given pattern.

The filling or the injection of the insulation layer material 110 between the two parallel exterior faces 107 and 108, as shown in FIG. 3a, is performed on a continuous basis, concurrently with the positioning of the fasteners and the unrolling of the two exterior faces. The steps in the continuous fabrication process are thus all performed simultaneously, although a certain cycle or sequence of events is followed with respect to a fixed position on the panel as it passes through the fabrication line 300.

Still referring to FIGS. 3a and 3b, cutters 310 cut the panel at the end of the fabrication line 300 (FIG. 3a). The cutting action is controlled by the encoder and the central computer. A signal is sent to the cutters 310 once a given length of panel material is measured by the encoder, the given length corresponding to a desired panel height 103. At least the insulation layer 110 is cut in order to form the two opposite cut ends 104 and 105 of the panel 100, as shown in FIG. 1. The cut end can be of any shape; straight, curved, angled or having indentations for example.

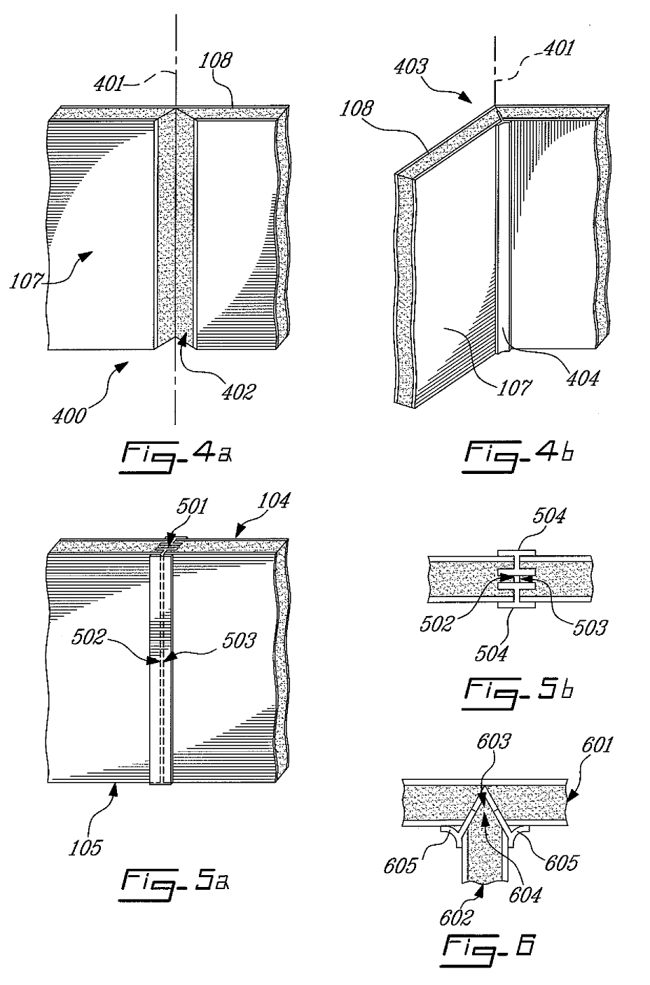

Referring to FIG. 4a, there is illustrated a modular panel 400 similar to the modular panel 100 of FIG. 1, with a fold line 401 and a longitudinal V-shaped portion 402 removed from the panel along the fold line 401. The longitudinal V-shaped portion 402 joins the two opposite cut ends 104 and 105, and points towards one of the two parallel exterior faces, here 108. Alternatively, the longitudinal V-shaped portion 402 can join the two opposite outer edges 101 and 102.

Referring to FIG. 4b, the folding line 401 along one of the parallel exterior faces (here 108) is for folding the modular panel along the fold line to create an angled or cornered modular panel 403. The angle is secured along the fold line 401 using adhesives placed along or inside the cavity formed by the removal of the longitudinal V-shaped portion 402. Adhesives such as glue or caulking can be used to seal. A molding 404 can also be inserted to obtain a curved interior corner finishing.

Referring to FIG. 5a and FIG. 5b, which illustrate different views of the modular panel 100 as illustrated in FIG. 1 having a longitudinal sectional portion (not shown) and removed at junction 501. The junction 501 connects the two opposite cut ends 104 and 105 to create two new parallel cut edges 502 and 503. These edges are fused back together to create a panel reduced in size. The junction 501 may follow any axis.

The removal of the longitudinal sectional portion permits the accommodation of a particular dimensional criteria. In this example, the panel's width 106 (see FIG. 1) is reduced. Alternatively, if the removed portion is along a lateral axis or such that the junction 501 connects the two opposite outer edges 101 and 102 (refer to FIG. 1), the panel's height 103 is reduced.

As illustrated in FIG. 5b, the two parallel cut edges 502 and 503 are fused back together using at least one of a combination of grooves and moldings 504. Adhesive means (not shown) can also be used to further secure and seal the resulting modular panel.

FIG. 6 shows a top view of the assembly of two modular panels 601 and 602 to form an angled intersection. Modular panels 601 and 602 are similar to the modular panel 100 of FIG. 1. A first modular panel 601 has a longitudinal V-shaped portion 603 removed. Hence, modular panel 601 resembles modular panel 400 of FIG. 4a. A second modular panel 602 has a longitudinal V-shaped projection 604 along any one of either the two opposite outer edges (101 and 102 of FIG. 1) or the two cut ends (104 and 105 of FIG. 1).

The V-shaped projection 604 points outwardly such that is may be inserted in the cavity formed by the removal of the V-shaped portion 603 of the first modular panel 601. The intersection is created by the insertion of panel 602 in the cavity of panel 601. The modular panels 601 and 602 are secured together by using moldings 605 and adhesive means (not shown).

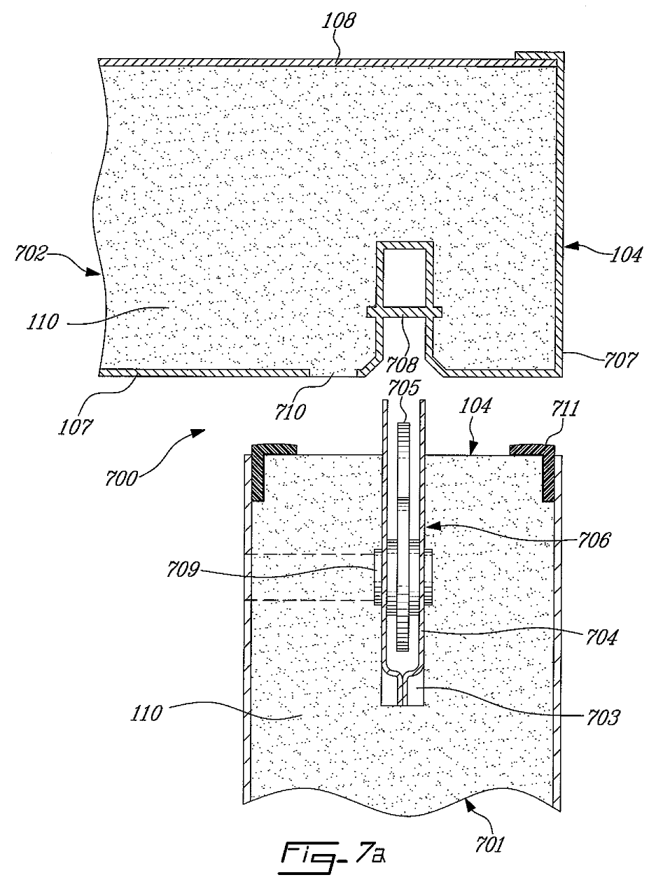

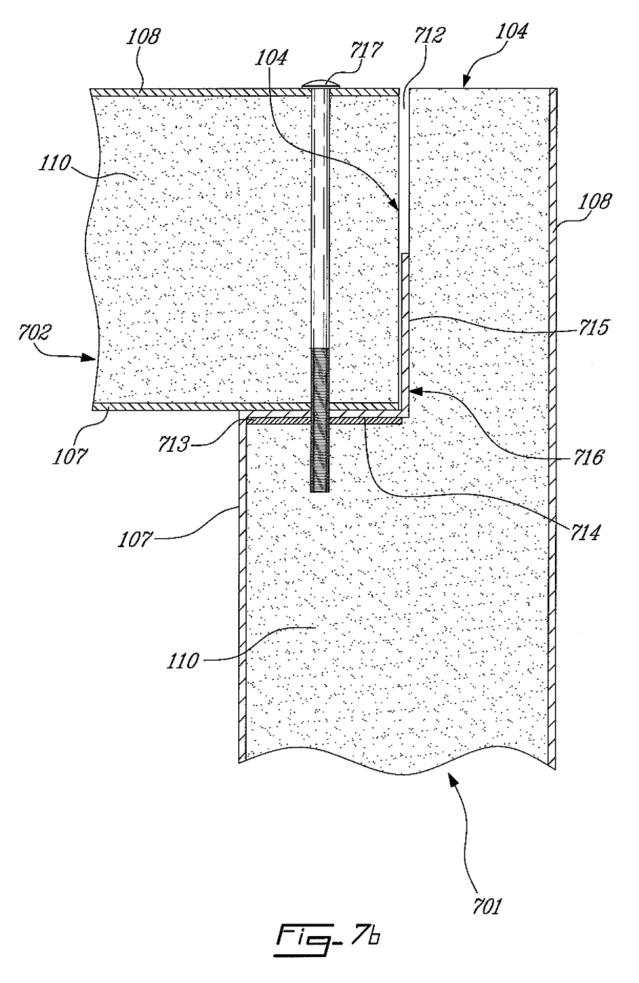

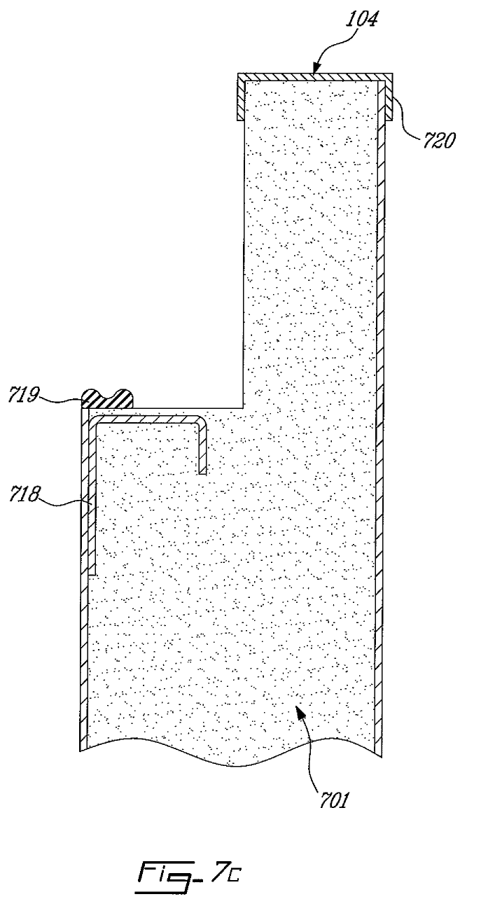

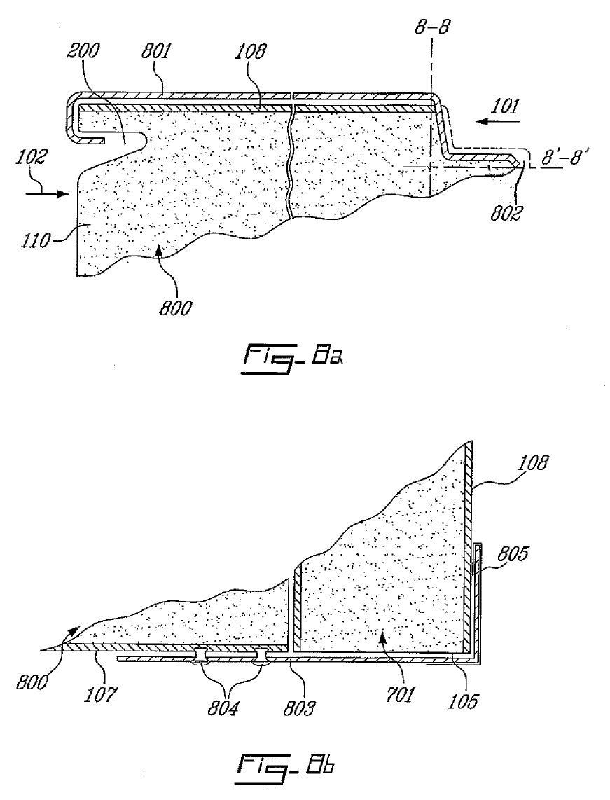

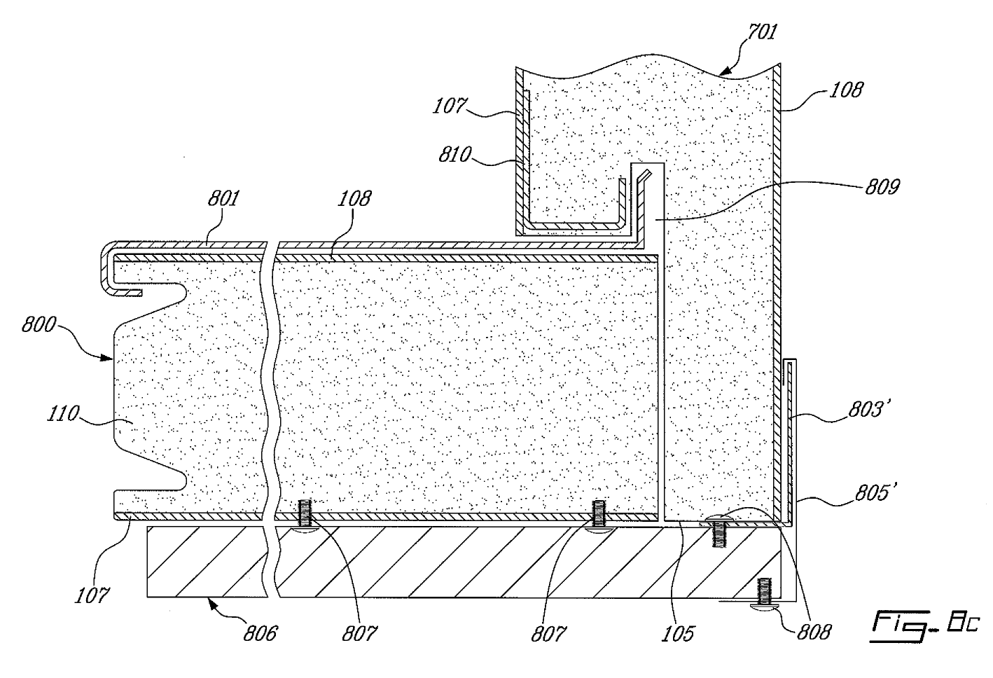

Now referring to FIG. 7a, there is shown a cross-section view of a pair of modular panels 701 and 702 assembled together to form a wall-to-roof junction 700. Modular panels 701 and 702 can be either one of a wall or a roof panel. It is however preferred that panel 701 forms an upright wall panel and that panel 702 forms a transverse roof panel. The wall panel 701 has a joint section defined by a local cut 703 performed within at least one of its two opposite cut ends, here 104. The local cut 703 permits the insertion of the housing 704 and hook 705 of a male fastener 706.

Still referring to FIG. 7a, the roof panel 702 has a joint section defined by a mold-locking device 707. The mold-locking device 707 is a mold having a structure for locking with the fastener 706 of the wall panel 701. The mold-locking device 707 is engaged along at least one of the panel's two opposite cut ends, here 104, or along at least one of the two opposite outer edges, 101 or 102 (refer to FIG. 1), of roof panel 702. The given edge of the roof panel 702 can be surrounded by the mold-locking device 707, as illustrated.

Prior to the engagement of the mold-locking device 707, a local continuous cut is made in the roof panel 702 such that the built-in locking structure of the mold-locking device 707 can be inserted into the insulation layer 110 of the panel. The built-in locking structure has a latch pin 708 such that the male fastener 706 of the wall panel 701 can lock with the latch pin 708.

The locking mechanism of all the fasteners herein described (111, 112 of FIG. 1 and here 706) is accessible via a locking hole performed within the modular panel (represented by dashed lines in FIG. 7a). The locking hole permits the use of an Allen key to lock or unlock the locking drive 709 of the fastener, here 706.

A thermal breakage point 710 can be performed between the edge of the mold-locking device 707 and start of the exterior face of the panel (here 107), to further prevent condensation. Gaskets 711 can also be used to seal the joint sections of the wall panel 701 and the roof panel 702 together.

FIG. 7b is a cross-section view showing a pair of modular panels assembled together to form a roof-to-wall junction according to a different junction technique. The joint section of the wall panel 701 is formed by removing a substantially rectangular portion of the insulation layer 110; this portion is herein illustrated as the portion 712. The removal of 712 permits an edge 104 of a roof panel 702 to be supported by the wall panel 701.

Once the substantially rectangular portion 712 is removed, a lath 713 is placed on the supporting cut edge 714 of the wall panel 701. The supporting cut edge 714 extends inwardly from at least one of the two parallel exterior faces, here 107, and for a distance defined by a part of the distance between the two parallel exterior faces 107 and 108 of the wall panel 701. A lateral cut edge 715 extends substantially vertically into the panel 701, from at least one of the two opposite cut ends, here 104, and for a distance defined by at least the distance between the two parallel exterior faces 107 and 108 of the roof panel 702.

Still referring to FIG. 7b, when the substantially rectangular portion 712 is removed from the wall panel 701, at least one of the two parallel exterior faces, here 107, is bent inwardly on the supporting cut edge 714, and partially onto the lateral cut edge 715, so as to follow the sides created by the removal of portion 712. This bent portion of the exterior face 107 is illustrated as the layer of material 716.

The layer of material 716 further secures the lath 713 onto the supporting cut edge 714 of the wall panel 701. An assembling screw 717 is used to secure the roof panel 702 and the wall panel 701 together. The assembling screw 717 is inserted from one of the two parallel exterior faces 108 of panel 702 to the second of the two parallel exterior faces 107 of the roof panel 702. The wall-to-roof junction is further secured by using adhesives (not shown) and gaskets (not shown).

Each panel illustrated by FIGS. 7a and 7b can be manufactured with their respective joint section such that they are easily assembled together on site.

FIG. 7c is a cross-section view of one of the modular panel 701 of FIG. 7b, with an embedded screwing lath 718. In this case, the layer of material 716 of FIG. 7b, is completely removed when the substantially rectangular portion 712 is removed from the wall panel 701. The screwing lath 718 is embedded in the wall panel 701 during the continuous fabrication process detailed hereinabove, and following a method such as the one described for the positioning of the fasteners within the modular panels (refer to FIGS. 3a and 3b).

A gasket 719 attached to the supporting cut edge 714 further ensures that the roof-to-wall junction is well sealed. Plastic caps and finishing materials can be added to the exposed edges of the panels (here cut end 104), such as cap 720.

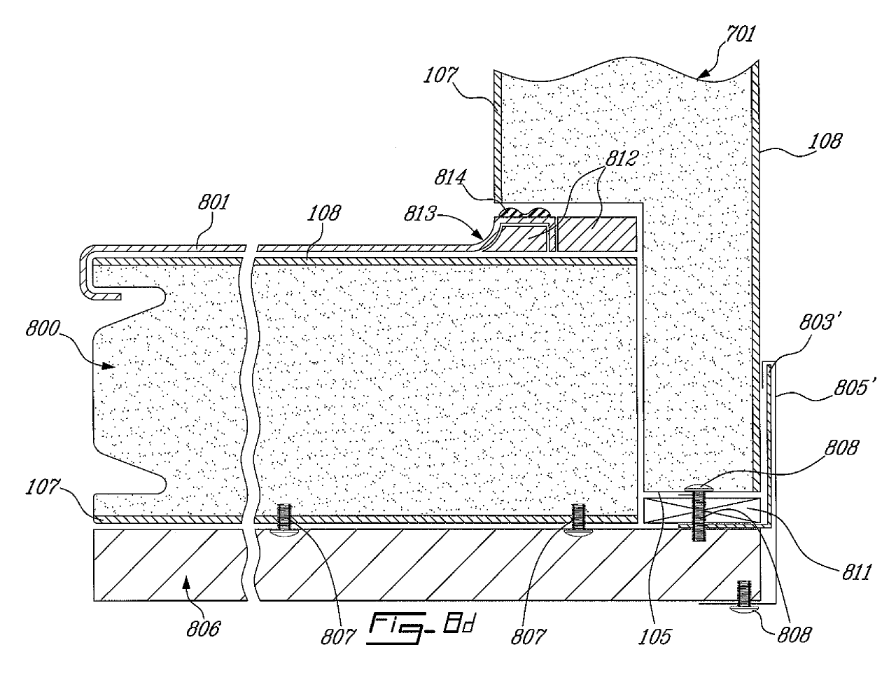

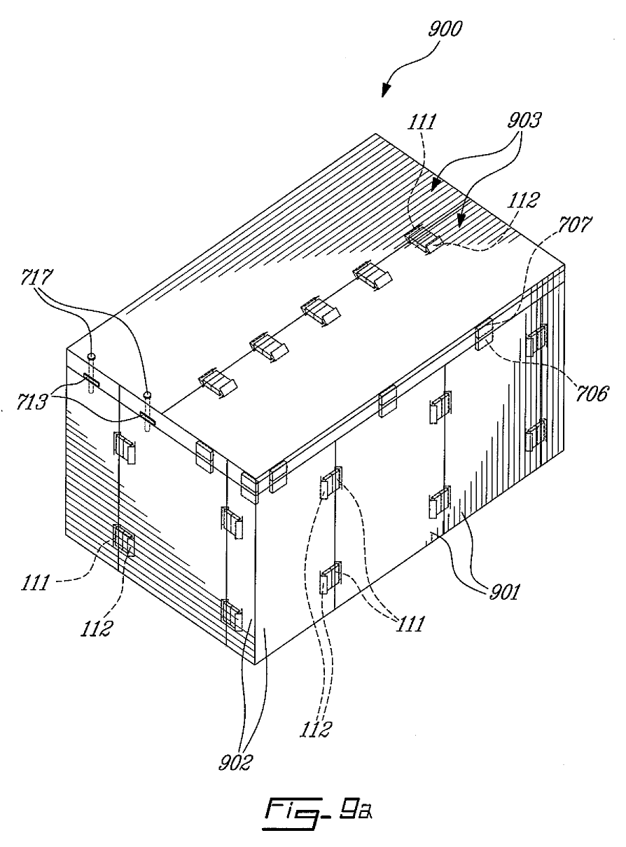

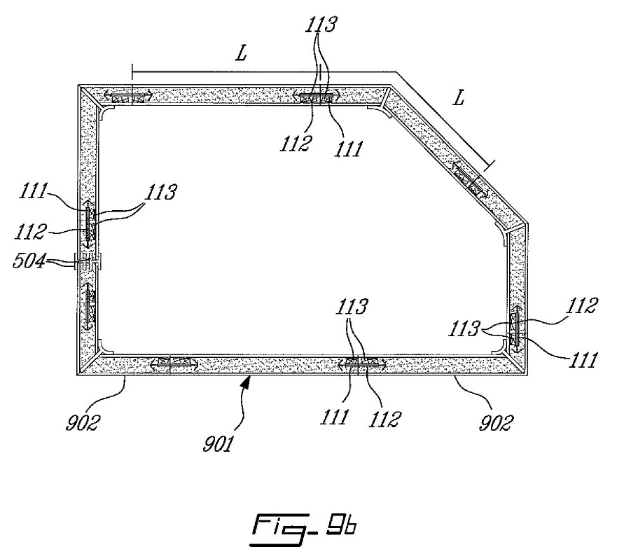

FIG. 8a is a cross-sectional view showing the modular panel of FIG. 1 for forming a floor panel 800, and thus having a floor cover 801. The floor cover 801 is a sheet of floor covering material such as a thick metallic sheet of gauge 16 to 18 for example. The floor cover 801 is attached to one of the exterior faces 107 (or 108 of FIG. 1) of the floor panel 800. More precisely, the floor cover 801 engages into a groove 200 of the floor panel 800 located at one outer edge 102 of the floor panel 800.

The second outer edge 1010f the floor panel 800 has a protrusion 802 (shown in dotted lines) for engaging in an adjacent panel (not shown) having a groove (not shown) such as groove 200, into which protrusion 802 can be inserted. The floor covering sheet 801 is inserted along outer edge 101 by cutting the protrusion 802 along the two dashed cut lines shown (8-8 and 8′-8′) and only as deep as their intersecting point. Alternatively, the entire outer edge 101 can be removed by cutting through the entire floor panel 800 following the dashed cut line 8-8. Then, the floor cover 801 can be bent around the remaining cut edge 101.

FIG. 8b is a cross-sectional view showing a pair of modular panels assembled together to form a floor-to-wall junction. The wall panel 701 (refer to FIGS. 7a, 7b and 7c) is secured to a floor panel 800 (refer to FIG. 8a) by using an anchoring device 803.

The anchoring device 803 is a device that allows engaging the exterior cut end 105 of wall panel 701. It is fastened to the bottom parallel exterior face (here 107) of floor panel 800. Rivets 804 are used to attach the anchoring device 803 to the floor panel 800. The anchoring device 803 can thus be attached to the floor panel 800 during manufacturing, and wall panel 701 can simply be engaged on the anchoring device 803 on site, upon assembly of the final unit.

The rivets 804 can be any other type of attaching device such as bolts, nails pins and the like, and adhesives.

The anchoring device 803 illustrated in FIG. 8b is a sheet of material having strong enough resistance to solidly fix both panels together. Additionally, the anchoring device 803 can have a hook-like form to cover the entire cut end 10s and rise over the parallel exterior face (here 108) of the wall panel 701, as illustrated.

A cover 805 can also be used to cover the rising edge of the anchoring device 803, at the exterior corner and over the exterior face 108 of the wall panel 701. The cover 805 can be of any material suitable for engaging over the edge of the anchoring device 803. The cover 805 can also be made to provide an aesthetic finishing touch to the junction area.

As an alternative embodiment of FIG. 8b, a portion of wall panel 701 is removed such that wall panel 701 partly engages over the top parallel exterior face (here 108) of the floor panel 800, as illustrated in FIG. 8c and FIG. 8d.

FIG. 8c is a cross-sectional view showing the pair of modular panels assembled together of FIG. 8b, with a base or floor spacer 806. More particularly, the base 806 is fixed to an exterior face 107 of the floor panel 800 using anchors or screws 807. Then, the anchoring device 803′ is fastened to a floor spacer 806 using a screw 808. Both the base 806 and the anchoring device 803′ thus secure the floor 800 and the wall panel 701 together during installation. Finally, a cover 805′ provides an aesthetic finishing touch to the junction area. The cover (805 and 805′) are made of metal or of any kind of plastic material.

Variations of this attachment scheme are possible, since the base 806 could very well have additional attachment and sealing features into which the wall panel 701 or the floor panel 800 securely engages.

Still referring to FIG. 8c, there is illustrated how the wall panel 701 is optionally modified to engage over a top parallel exterior face (here 108) of the floor panel 800. In such a case, a portion of the wall panel 701 is removed to form cavity 809. This portion is located at the cut end 105 of the wall panel 701 such that a substantially right-angled junction can be made between the floor and the wall panel 800 and 701 respectively.

The cavity 809 engages on a hook formed by the bending of the floor cover 801. A reinforcement device 810, preferably placed in the wall panel 701 during the automated fabrication process detailed hereinabove, further ensures that the wall panel 701 remains securely engaged to the floor panel 800. The reinforcement device 810 is made to resist against the pressure of the portion of floor cover 801 inserted inside the cavity 809 of the wall panel 701.

FIG. 8d is a cross-sectional view showing the assembled pair of modular panels of FIG. 8c, with spacers 811 and 812. The spacers are placed such that a curved interior floor-to-wall junction 813 can be obtained.

A first spacer 811 is placed between the cut end 105 of the wall panel 701 and the base 806 to elevate the wall panel 701 such that the floor cover 801 can be curved upwards at the curved interior junction 813.

A second combination of spacers 812 are placed at a cut end or an outer edge of the floor panel 800, on top of the exterior face 108 and below a portion of the floor cover 801. The spacers 812 are such that once the wall panel 701 is partly engaged over the floor panel 800, both the floor cover 801 and the spacers 812 are secured due to the weight of the wall panel 701.

As illustrated in FIG. 8d, at least one of the spacers 812 fills the space below the floor cover 801 in a curved fashion. A gasket 814 is used to seal the the floor cover 801 with the exterior face 107 of the wall panel 701.

The spacers 811 and 812 can be made of one single block of material or a combination of blocks of material. Material types can vary although the chosen material is preferred to be resistant temperature and provide proper isolation. PVC foam blocks or neoprene joints are examples.

Referring to FIG. 9a, several modular panels such as the ones shown in FIGS. 1 to 8d are assembled together to form an insulated room 900 according to desired attributes. For assembly, the modular panels are defined as wall panels 901 and roof panels 903, which can similarly be seen as floor panels (not shown). Corner or angled wall panels 902 form the corners of the refrigeration unit 900. Many combinations can therefore be performed to create various room architectures. The walls are assembled by locking male fasteners 112 with female fasteners 111 on each of the two opposite outer edges of each of the modular panels (either wall panels 901, roof or floor panels 903, or angled modular panels 902).

Doors (not shown) can also be assembled according to variations of the described fabrication method. For example, a door knob, a closing device and rotating joints can be inserted in a modular panel during fabrication. Finally, for aesthetic purposes, the exposed cut ends or other external edges of the assembled modular panels can be sealed by plastic caps or other finishing materials.

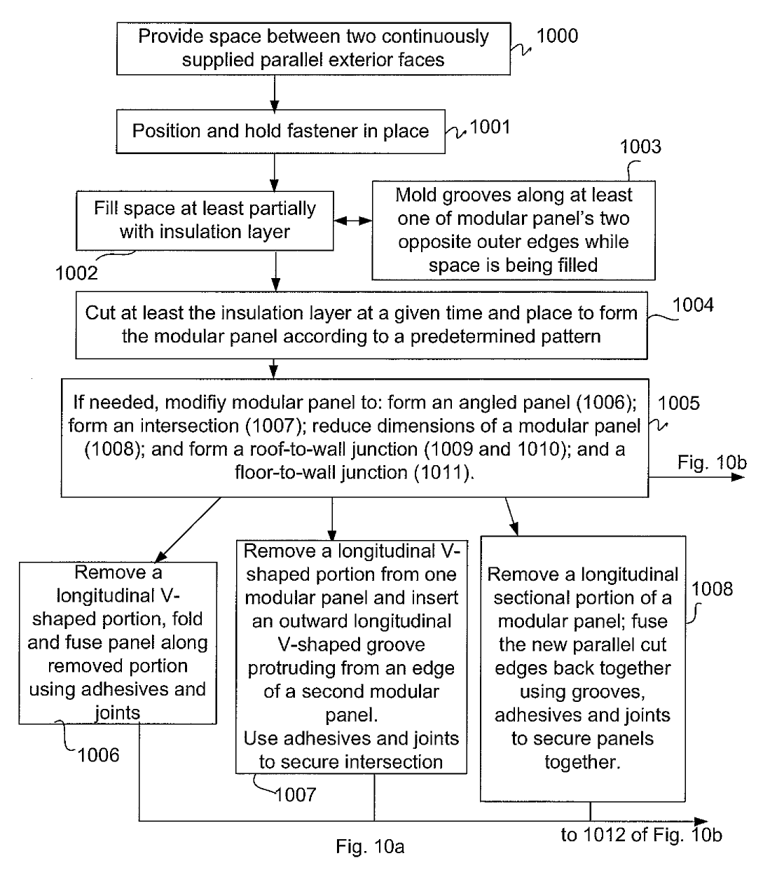

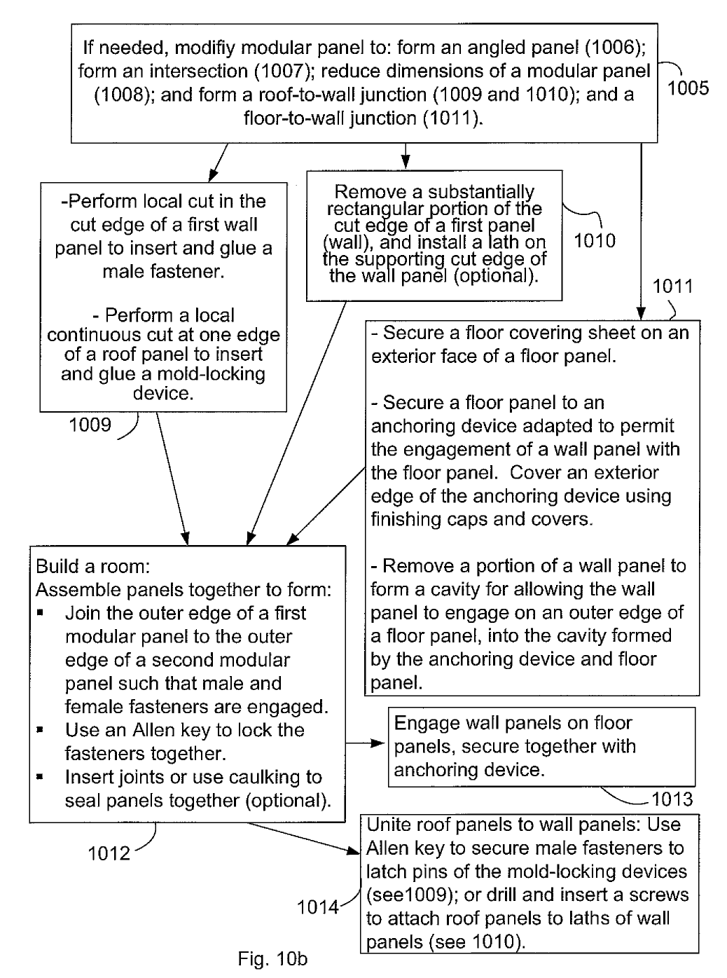

FIG. 9b is a top cross-sectional view of an assembly of modular panels forming the perimeter of an isolated room. As an example, modular panels having a given fixed width are assembled together to form the perimeter of the room. If the perimeter is not a multiple of the fixed width, a single “closing” panel can be formed by removing a longitudinal portion of the panel such that its width is reduced, as described in FIGS. 5a and 5b. This practice reduces the amount of waste material which would inevitably follow from more extensive on-site panel modifications. FIGS. 10a and 10b, are block diagrams illustrating a method for fabricating a modular panel as shown in FIG. 1 and assembling modular panels to build an isolated room 900 (refer to FIG. 9a). FIGS. 10a and 10b thus summarize in essence the above-described subject matter.

To fabricate a modular panel as shown in FIG. 1, a space between two continuously supplied parallel exterior faces is supplied in step 1000. The parallel exterior faces can be made of a material such as a sheet of plastic, metal, or any other device for enclosing a space.

In step 1001, once the space is provided, the fasteners are positioned at a given rate using positioning arms, and held in place at their given positions using positioning devices. The positions are in accordance with a customizable predetermined pattern. The fasteners are placed within the space and usually along or at one of the two opposite outer edges of the panel.

In step 1002, the space is at least partially filled with an insulation layer. This step is performed on a continuous basis, as the parallel exterior faces pass through the fabrication line, and while the fasteners are being placed and held in position.

In step 1003, molded grooves can be formed along the two opposite outer edges of the panel being fabricated by using molds such that the insulation layer filling the space takes on the shape of the molds.

In step 1004, the continuous fabrication cycle performed by the automated fabrication line 300 terminates by the cutting of at least the insulation layer of the panel being fabricated to from the modular panel according to desired dimensions.

The following steps, 1005 to 1011, are optional modifications which can be performed on the fabricated modular panels such that the panels can later be assembled together to form an insulated room. The assembly steps are described by steps 1012 to 1014.

Still referring to FIG. 10a, block 1005 has six sub-blocks 1006 to 1011 describing the possible modifications which can be performed on the modular panels.

In step 1006, an angled modular panel is created by removing a longitudinal V-shaped portion of the panel, folding the panel along the longitudinal fold line of the removed portion, and fusing the corner junction using adhesives and joints (refer to FIG. 4a and FIG. 4b).

In step 1007, an intersection of two modular panels is created (refer to FIG. 6). In this step, a longitudinal V-shaped portion is removed from a first modular panel to form a cavity. A longitudinal V-shaped groove protruding from an outer edge of a second modular panel is then inserted in the cavity of the first modular panel, thereby creating the angled intersection. The intersection is then further secured by using adhesives and joints.

In step 1008, a longitudinal portion of a modular panel is removed to reduce the size of the modular panel, such as its width (refer to FIG. 5a and FIG. 5b). Once the portion is removed, the panel is fused back together using adhesives and joints. The portion removed can be cut so as to have grooves. The grooves help in joining the remaining portions of the panel back together.

FIG. 10b is a block diagram illustrating other steps (1009-1014) for assembling the modular panels together, as a continuation of FIG. 10a.

In step 1009 and 1010, a roof-to-wall junction is performed.

In step 1009, one performs a local cut within at least one of the two opposite cut ends of a first modular panel and inserts a male fastener in the local cut. Then, a local continuous cut is performed to insert a mold-locking device into at least one of the two opposite cut ends and the two opposite outer edges of a second modular panel. The mold-locking device is a single unit apparatus that has a latch pin for locking to a male fastener, and that encapsulates the outer edge of the cut end of the modular panel (refer to FIG. 7a).

In step 1010, one performs a substantially rectangular cut to remove the substantially rectangular portion from the cut edge of a first panel (wall panel), refer to FIG. 7b and FIG. 7c. The substantially rectangular cut removes a part of the insulation layer of the modular panel, and thus forms a supporting cut edge and a lateral cut edge within the insulation layer of the remaining wall panel; both of these edges being substantially perpendicular to one another. Ideally, the supporting cut edge extends inwardly from a least one of the two parallel exterior faces for a distance defined by part of the distance between the two parallel exterior faces. The lateral cut edge extends inwardly from at least one of the two opposite cut ends of the modular panel for a distance defined by the insulated layer of the roof panel. The parallel exterior face which is let free to move after the rectangular cut has been performed can then be entirely cut or bent inwardly such that it at least partially covers the supporting cut edge. A lath is placed on the supporting cut edge to further secure an assembling screw that is to be inserted in a second modular panel (the roof panel), such that the assembling screw secures the wall panel to the roof panel. The assembling screw is inserted substantially near at least one of the two opposite outer edges and one of the two opposite cut ends, such that it traverses the modular panel forming the roof panel (from one of the two parallel exterior faces to the second).

Still referring to FIG. 10b, a floor-to-wall junction is created in step 1011. Various alternatives exists, though the main steps are described as follows: A floor covering sheet is placed on one of the exterior faces of the modular panel to form the floor of the insulated room. The floor covering sheet is secured onto the modular panel by being inserted in a groove 200 located at one outer edge of the floor panel and shaped to substitute a protrusion 802 located at an opposite outer edge of the floor panel. The floor panel can also be secured to an anchoring device from one bottom exterior face of the panel so as to form a cavity into which a wall panel can be inserted during assembly (refer to FIGS. 8a to 8d). A portion of a wall panel is also removed such that the wall panel can engage around an edge of a floor panel and into the cavity of the anchoring device.

Steps 1012 to 1014 describe the action of assembling the various modular panels together to from the structural unit having a roof, walls, angled walls and intersections. A floor can optionally be assembled as well.

In step 1012, two modular panels are assembled together by joining an outer edge of a first modular panel to a corresponding outer edge of a second modular panel such that male and female fasteners are engaged together. An Allen key is then used to lock the fasteners. Joints, caulking or any sealant can also be used to ensure a sealed junction. This step enables the assembly of wall, floors and roof separately or concurrently with their junction (floor to wall and roof to wall).

For example, in step 1013, once the floor panels are assembled together, side by side, the wall panels are secured with the floor panels. An anchorage sheet, rivets and screws such as described in FIGS. 8b to 8d are used to secure a wall panel to a floor panel. Spacers can be used to form a curved inside junction between the two panels, and a base can also be inserted between the panels and the anchoring device if desired. Finishing plastic covers or caps can be used to protect the junctions.

Finally, in step 1014, while the roof panels are assembled together, side by side, they can also be secured to the wall panels.

If the roof and wall panels are as modified in step 1009, an Allen key is used to secure the male fastener of the wall panel to the lath in the mold-locking device of the roof panel (refer to FIG. 7a).

If the roof and wall panels are as modified in step 1010, a hole is drilled and an assembling screw is inserted to attach the roof panel to the lath of the wall panel (refer to FIG. 7b and FIG. 7c).

The panels can have further modifications to allow for doors or other built-in electrical monitoring and control devices for example. It is understood that the assembly method herein proposed can vary depending on the particularities of the room to be built.

The embodiments of the invention described above are intended to be exemplary only, and it is understood that the embodiments may be substantially varied while remaining in the scope of the description, which is intended to be limited solely by the scope of the appended claims.

What is claimed is:

1. A modular panel comprising:
two opposite outer edges;
two parallel exterior faces having a space therebetween, said space also enclosed within said two opposite outer edges;
an insulation layer at least partially filling said space;
a fastener positioned along at least one of said two opposite outer edges; and
a positioning device for positioning said fastener at a given distance from at least one of said two parallel exterior faces.

2. The modular panel as in claim 1, wherein said fastener is located within said space 3. The modular panel as in claim 2, wherein said insulation layer holds said fastener in place.

4. The modular panel as in claim 1, said positioning device comprising at least one of a supporting block of material and a portion extending from said fastener.

5. The modular panel as in claim 1, wherein at least one of said two parallel exterior faces comprises a sheet of material.

6. The modular panel as in claim 5, further comprising an adhesive for holding said fastener to said sheet of material.

7. The modular panel as in claim 5, wherein said sheet of material comprises at least one of a sheet of plastic, a sheet of metal and a sheet of aluminum.

8. The modular panel as in claim 1, further comprising at least two opposite cut ends perpendicular to said two opposite outer edges.

9. The modular panel as in claim 8, wherein at least one of said two opposite outer edges further comprises a groove.

10. The modular panel as in claim 8, wherein said fastener comprises a number of fasteners placed at a series of given positions along at least one of said two opposite outer edges according to a predetermined pattern.

11. The modular panel as in claim 8 for forming an angled modular panel, said modular panel further comprising a longitudinal V-shaped cavity between said two opposite cut ends to permit the folding of one of said parallel exterior faces along said longitudinal V-shaped cavity using adhesives and joints, to form said angled modular panel.

12. The modular panel as in claim 8, further comprising two parallel cut edges resulting from the removal of a longitudinal sectional portion from said modular panel and between said two opposite cut ends, said two parallel cut edges each comprising at least one groove for securing said two parallel cut edges together using at least one of a molding and adhesives.

13. The modular panel as in claim 11 for forming an angled intersection with a second modular panel, said second modular panel comprising a longitudinal V-shaped projection along at least one of said two opposite outer edges, said longitudinal V-shaped projection for inserting and fixing into said longitudinal V-shaped cavity of said modular panel using adhesives.

14. The modular panel as in claim 8 for forming a substantially right angled roof-to-wall junction with a second modular panel, said modular panel further comprising:
a local cut within at least one of said two opposite cut ends; and
a male fastener inserted within said local cut, for locking with a locking device of said second modular panel.

15. The modular panel as in claim 14, wherein the locking device of said second modular panel comprises a mold-locking device inserted into a local continuous cut performed in at least one of: said two opposite cut ends and said two opposite outer edges; and
wherein said mold-locking device comprises a latch pin for locking with said male fastener of said modular panel.

16. The modular panel as in claim 15, wherein the modular panel is a wall panel and the second modular panel is a roof panel.

17. The modular panel as in claim 8 for forming a substantially right angled roof-to-wall junction with a second modular panel, said modular panel further comprising:
a cavity formed by the removal of a substantially rectangular portion of said insulation layer, the cavity having a supporting cut edge and a lateral cut edge, said supporting cut edge extending inwardly from at least one of said two parallel exterior faces for a distance defined by part of a distance between said two parallel exterior faces, and said lateral cut edge extending inwardly from at least one of said two opposite cut ends for a distance defined by at least said distance; and
a lath on said supporting cut edge, said lath for securing with an engaging device extending from said second modular panel.

18. The modular panel as in claim 17, wherein the engaging device of said second modular panel comprises an assembling screw traversing said second modular panel for securing said second modular panel to said lath of said modular panel.

19. The modular panel as in claim 18, further wherein at least one of said supporting cut edge and said lath is at least partially covered by a layer of material, said layer of material being one of said two parallel exterior faces bent inwardly into said cavity.

20. The modular panel as in claim 17, wherein the modular panel is a wall panel and the second modular panel is a roof panel.

21. The modular panel as in claim 9, further comprising a floor covering sheet placed over a first one of said two parallel exterior faces, secured on said modular panel by at least being partially engaged into said groove of one of said two opposite outer edges.

22. The modular panel as in claim 21, further comprising an anchoring device secured to a second one of said two parallel exterior faces of said modular panel using one of screws and rivets, said anchoring device for engaging on one of said two parallel exterior faces of a second modular panel to secure the two modular panels together to form a substantially right-angled floor-to-wall junction.

23. The modular panel as in claim 21, wherein said floor covering sheet of said modular panel further comprises an engagement section for securely engaging into a cavity formed in said second modular panel by the removal of a portion of said second modular panel located at one of said two opposite cut ends of said second modular panel, and to permit the location of said modular panel into said cavity.

24. A method for fabricating a modular panel, said method comprising a continuous production cycle comprising:
providing a space between two parallel exterior faces which are continuously supplied, said space also enclosed between two opposite outer edges;
positioning a fastener within said space, along at least one of said two opposite outer edges, said positioning performed at a given rate to form a predetermined pattern, and while said space is being provided;
at least partially filling said space with an insulation layer, said insulation layer being also used for holding said fastener in place; and
cutting at least said insulation layer to form said modular panel.

25. The method of claim 24, wherein positioning said fastener comprises holding said fastener in place using a positioning device, said positioning device being at least one of a supporting block of material and a portion extending from said fastener.

26. The method as in claim 24, wherein said positioning of said fastener further comprises using an encoder to determine a time of positioning to place said fastener according to the predetermined patter, during said continuous production cycle.

27. The method as in claim 24, wherein providing a space between said two parallel exterior faces comprises providing a space between two sheets of material, each of said two sheets of material corresponding to each of said two parallel exterior faces, said sheets of material being at least one of a sheet of plastic and a sheet of metal.

28. The method as in claim 27, wherein said positioning of said fastener further comprises using adhesives to hold said fastener in place on at least one of said sheets of material.

29. The method as in claim 24, wherein said cutting comprises using an encoder to creating at least two opposite cut ends perpendicular to said at least two opposite outer edges and according to the predetermined pattern.

30. The method as in claim 29, wherein the continuous production cycle further comprises creating a groove along at least one of said at least two opposite outer edges, said groove formed at least during said filling of said insulation layer.

31. The method as in claim 24, wherein said positioning of said fastener comprises positioning a number of said fasteners at a series of given positions along at least one of said two opposite outer edges using an encoder, and according to said predetermined pattern.

32. The method as in claim 29, further comprising:
removing a longitudinal V-shaped portion between said two opposite cut ends to define a longitudinal V-shaped cavity; and
folding one of said two parallel exterior faces along the longitudinal V-shaped cavity using at least one of a joint and adhesives to form an angled modular panel.

33. The method as in claim 29, further comprising:
removing a longitudinal V-shaped portion between said two opposite cut ends to define a longitudinal V-shaped cavity; and
joining said modular panel to a second modular panel at a substantially right angle using adhesives and a joint, said second modular panel having a longitudinal V-shaped projection along at least one of said two opposite outer edges.

34. The method as in claim 29, further comprising:
removing a longitudinal sectional portion from said modular panel, said longitudinal sectional portion joining said two opposite cut ends to define two parallel cut edges each comprising at least one groove; and
securing said two parallel cut edges back together using at least one of a molding and adhesives to form a modular panel of a reduced size.

35. The method as in claim 29, further comprising forming a substantially right-angled roof-to-wall junction with a second modular panel by:
inserting a male fastener in a local cut performed in said modular panel, within at least one of said two opposite cut ends of said wall panel;
engaging a mold-locking device in a local continuous cut performed in said second modular panel, into at least one of said two opposite cut ends and said two opposite outer edges of said roof panel, and
locking said male fastener of said modular panel to a said mold-locking device of said second modular panel.

36. The method as in claim 29, further comprising forming a substantially right-angled roof-to-wall junction, with a second modular panel by:
removing a substantially rectangular portion of said insulation layer to define a cavity having a supporting cut edge and a lateral cut edge, said supporting cut edge extending inwardly from at least one of said two parallel exterior faces for a distance defined by part of a distance between said two parallel exterior faces, and said lateral cut edge extending inwardly from at least one of said two opposite cut ends for a distance defined by at least said distance;
placing a lath on said supporting cur edge; and
screwing a screw traversing said second modular panel to said lath on said modular panel to secure said junction.

37. The method as in claim 36, wherein said forming further comprises:
bending said at least one of said two parallel exterior faces inwardly within said cavity to partially cover at least one of said supporting cut edge and said lath.

38. The method as in claim 30, further comprising:
placing a floor covering sheet over at least one of said two parallel exterior faces; and
securing said floor covering sheet on said modular panel by at least partially inserting said floor covering sheet into said groove of one of said two opposite outer edges.

39. The method as in claim 38, further comprising:
attaching an anchoring device to a second one of said two parallel exterior face of said modular panel using one of screws and rivets, and
securing said anchoring device on one of said two parallel exterior faces of a second modular panel to secure the two modular panels together and form a substantially right-angled floor-to-wall junction.

40. The method as in claim 39, further comprising
forming a cavity in said second modular panel by removing of a portion located at one of said two opposite cut ends of said second modular panel;
placing said modular panel in said cavity of said second modular panel; and
engaging said floor covering sheet of said modular panel into said cavity of said second modular panel.

41. A modular panel having two parallel exterior faces for enclosing a space and a fastener, said fastener being positioned within said space during the continuous production cycle of claim 24.

42. The modular panel as in claim 41, wherein said fattener is positioned within said space according to a predetermined pattern using an encoder.
